(19) United States
(12) Patent Application Publication
(10) Pub. No.: US 2015/0375399 A1
(43) Pub. Date: Dec. 31, 2015

(54) USER INTERFACE FOR MEDICAL ROBOTICS SYSTEM

(71) Applicant: Hansen Medical, Inc., Mountain View, CA (US)

(72) Inventors: Joanne Chiu, Sunnyvale, CA (US); Sean P. Walker, Fremont, CA (US); June Park, San Jose, CA (US); Kamini Balaji, San Francisco, CA (US)

(21) Appl. No.: 14/719,034

(22) Filed: May 21, 2015

Related U.S. Application Data
(60) Provisional application No. 62/018,032, filed on Jun. 27, 2014.

(51) Int. Cl. B25J 13/08; G06F 3/03; B25J 9/16; G06F 3/01

(52) U.S. Cl. CPC B25J 13/08; G06F 3/017; G06F 3/0304; B25J 9/1656; B25J 9/1612; Y10S 901/09

(57) ABSTRACT

An exemplary illustration of a user interface for a medical robotics system may include multiple light sources configured to illuminate a gesture within a field of view. The user interface may further include multiple cameras, which have a field of view and are configured to generate a detection signal in response to detecting the gesture within the field of view. The user interface can also have a controller configured to generate a command signal based on the detection signal. The command signal may be configured to actuate an instrument driver, a display device, a C-arm configured or any combination thereof to perform a function mapped to the gesture.

### CROSS-REFERENCE TO RELATED APPLICATIONS

This application claims priority to U.S. Provisional Application No. 62/018,032, User Interface for Medical Robotics System, filed Jun. 27, 2014, which is incorporated by reference in its entirety herein.

### BACKGROUND

Medical device manufacturers are continuously developing user interfaces and user interface devices that intuitively perform various robot-assisted surgical procedures. The user interfaces may be integrated within onsite workstations located in operating rooms or at remote workstations outside of the operating rooms. The user interfaces may include keyboards, sliders, joysticks, tracking balls, touchscreens or any combination of the same to control medical devices and systems, such as robotic catheters and wires in vascular procedures. These user interfaces can require hand contact to manipulate the keys, sliders, joysticks, tracking balls or touchscreens, thus requiring somewhat extensive procedures to diligently maintain and restore sterility of the user interfaces.

Therefore, a need exists for a user interface for a medical robotics system that provides intuitive control of the system and can improve the sterility of the same.

### SUMMARY

An exemplary illustration of a user interface for a medical robotics system may include a plurality of light sources configured to illuminate a gesture within a field of view. The user interface may further include a plurality of cameras, which are configured to generate a detection signal in response to detecting the gesture within the field of view. The user interface may also include a controller configured to generate a command signal based on the detection signal. The command signal may be configured to actuate an instrument driver, a display device, a C-arm or any combination thereof configured to perform a function mapped to the corresponding command signal.

An exemplary illustration of a medical robotics system can include a user interface having a plurality of light sources, a plurality of cameras, a controller and a non-transitory computer readable medium. The system may further include an instrument driver, a display device, a C-arm or any combination thereof configured to perform a function mapped to a corresponding command signal, in response to receiving the command signal from the controller. The light sources may be configured to illuminate a gesture within a field of view, and the cameras may be configured to generate a detection signal in response to detecting the gesture. The controller may be configured to generate the command signal in response to receiving the corresponding detection signal from the cameras. The non-transitory computer readable medium may include a reference lookup table stored thereon that includes a plurality of reference command data mapped to a plurality of reference detection data, such that the controller generates the command signal based on reference command data corresponding to the detection signal.

An exemplary illustration of a method for operating a user interface for a medical robotics system may include illuminating a gesture within a field of view and generating a detection signal in response to detecting the gesture within the field of view. The method may further include generating a command signal in response to receiving the detection signal, and actuating an instrument driver, a display device, a C-arm or any combination thereof configured to perform a function mapped to the gesture.

### BRIEF DESCRIPTION OF THE DRAWINGS

FIG. 1A is a schematic view of one embodiment of a medical robotics system having user interfaces that are configured to operate the system in response to detecting a hand gesture or tool within a field of view;

FIG. 1B is an enlarged view of the exemplary illustrations of user interfaces of FIG. 1A as taken from within the encircled portion 1B;

FIG. 2 is an enlarged view of a hand gesture configured to be detected by the user interfaces of FIG. 1A to control movement of a catheter;

FIG. 3 is an enlarged view of a hand gesture configured to be detected by the user interfaces of FIG. 1A to control a view angle of a fluoroscope;

FIG. 4 is an enlarged view of a hand gesture configured to be detected by the user interfaces of FIG. 1A to control movement of a C-arm;

FIG. 5 is a perspective view of a hand gesture configured to be detected by the user interfaces of FIG. 1A to lock or disable the user interface or another portion of the system; and

FIG. 6 is a representative flow chart of a method for operating the user interfaces of the medical robotics system of FIGS. 1A and 1B.

### DETAILED DESCRIPTION

Referring now to the discussion that follows and also to the drawings, illustrative approaches are shown in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive or otherwise limit or restrict the claims to the precise forms and configurations shown in the drawings and disclosed in the following detailed description.

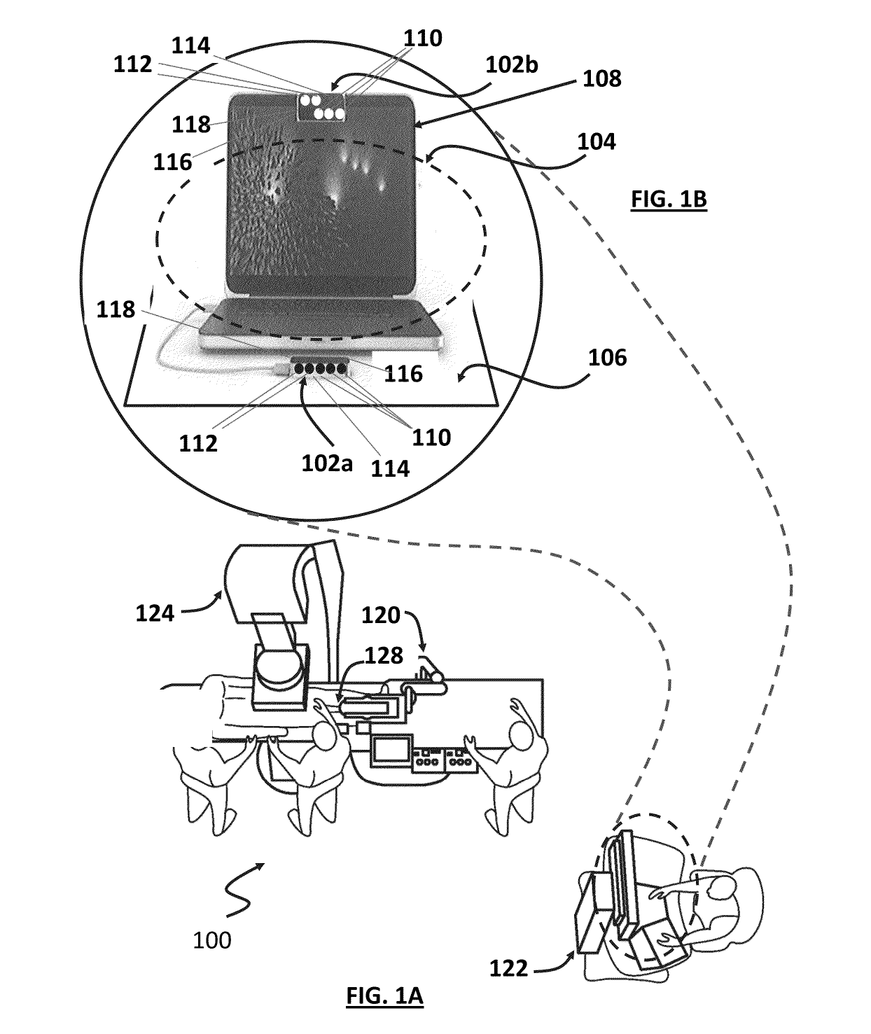

Referring to FIGS. 1A and 1B, one exemplary illustration of a medical robotics system 100 includes user interfaces 102a, 102b configured to operate the system 100, based on the detection of gestures within a field of view 104. In particular, this system 100 is configured to be operated without hand contact on, for example, buttons, keyboards or touchscreens, thus reducing the probability of contaminating a sterile surgical environment. Examples of gestures detected by the user interfaces 102a, 102b can include static hand gestures, dynamic hand movements, static tool configurations, dynamic tool movements or any combination thereof

The user interfaces 102a, 102b can be disposed in respective planes and arranged approximately perpendicular to one another, to provide a field of view having multiple lines of sight that can detect overlapping fingers that may be hidden when only one sensor is used. For instance, while one finger may block the line of sight from one interface to another finger, the other interface can be disposed in a sufficient position to detect the hidden finger. In particular, the first user interface 102a may be configured to be disposed on a somewhat horizontal top surface 106, such as a workstation table surface, while the second user interface 102b may be carried or supported by a substantially vertical surface 108, such as a monitor panel. This arrangement can permit the user interfaces 102a, 102b to detect and analyze a hemispherical field of view. However, in some embodiments, the user interfaces 102a, 102b may include other suitable arrangements and detect fields of view having other configurations, and the system 100 may include more or less than two user interfaces.

Each one of the user interfaces 102a, 102b can further include a plurality of light sources 110 configured to illuminate a gesture within the field of view 104. In one embodiment, each one of the user interfaces 102a, 102b may have three infrared LEDs. In some embodiments, each interface 102a, 102b may include more (e.g., four, five, six, seven, eight, nine, ten, etc.) or less (e.g., two, one, zero, etc.) than three infrared LEDs, and the interfaces 102a, 102b may include other suitable non-infrared LEDs or other suitable light sources, for example incandescent bulbs.

Further, in some embodiments, each one of the user interfaces 102a, 102b further includes one or more infrared cameras 112 configured to detect the gestures within the field of view 104 and generate a detection signal in response to detecting the same. However, in some embodiments, the user interfaces 102a, 102b may include more (e.g., three, four, five, six, seven, eight, nine, ten, etc.) or less (e.g., one, zero, etc.) than two infrared cameras. Furthermore, the user interfaces 102a, 102b may include RGB cameras, non-infrared cameras or other suitable sensors configured to detect gestures without requiring contact between the hand and the system 100.

In some embodiments, each one of the user interfaces 102a, 102b includes a controller 114 configured to generate a command signal based on the detection signal. For example, each user interface 102a, 102b may include a housing 116 that includes the LEDs 110, the cameras 112 and the controller 114 disposed therein. In one embodiment, the controller 114 is a separate component that is not disposed within or carried by the housing 116. For example, the system 100 may include only one common controller that is used for both user interfaces, and this controller may not be disposed within the housing but rather this controller may be integrated within a separate computer workstation.

In some embodiments, each user interface 102a, 102b includes a non-transitory computer readable medium 118 that is configured to store a reference lookup table that includes reference command data mapped to corresponding reference detection data. For example, the controller 114 receives the detection signal from the cameras and accesses the computer readable medium 118, so as to generate the command signal based on the reference command data corresponding with the detection signal. The medium 118 may be disposed within or carried by the housing 116 of the respective user interface 102a, 102b. Alternatively, in some embodiments, the medium 118 is a component of a separate computer, such as a computer workstation or various general purpose computers. Further, in some embodiments, the system does not include the reference lookup table, but rather this system may include an algorithm that can process the detection data without the table to determine and generate command signals.

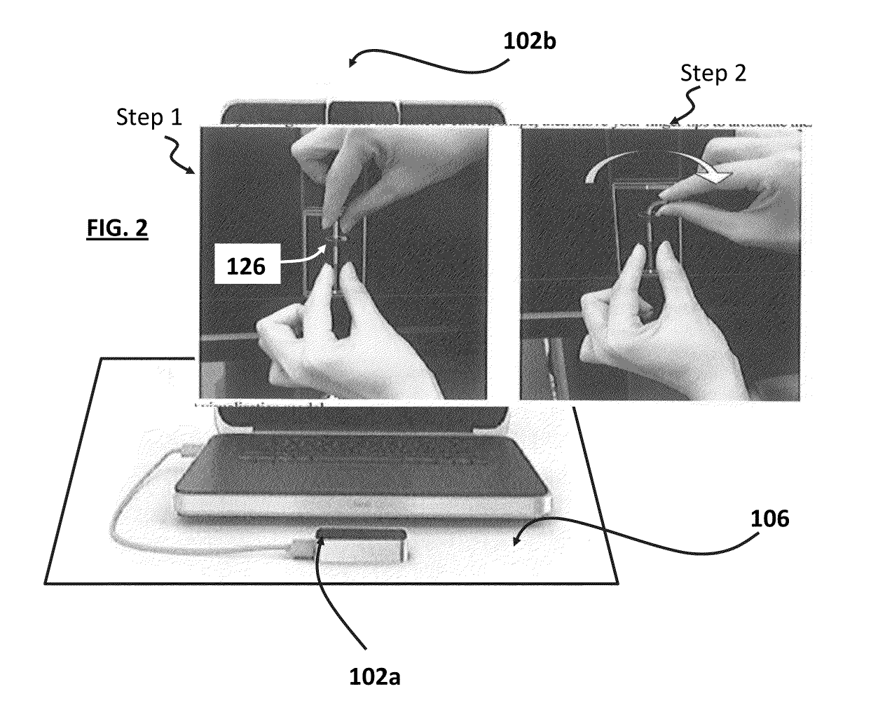

In some embodiments, as shown in FIG. 1A, the system 100 further includes an instrument driver 120, a display device 122, a C-arm 124, other suitable devices or any combination thereof, which are configured to receive the command signal from the controller 114 and perform a function corresponding to the same. For example, the cameras 112 are configured to generate the detection signal in response to detecting a gesture that is provided by a hand or a tool. Examples of the gestures include static hand gestures, dynamic hand movements, static tool configurations, dynamic tool movements or any combination thereof. In some embodiments, the cameras 112 are configured to generate the detection signal in response to detecting one gesture, which is configured to move a virtual catheter within the field of view in a rolling motion, an articulation motion, an insertion motion, a retraction motion, or any combination of the same. In such embodiments, the computer readable medium 118 includes reference detection data corresponding with the detection signal for this gesture, and the associated reference command data may be configured to actuate the instrument driver 120 to articulate, roll, insert, or retract a catheter, guidewire, or any other type of elongate member. As shown in FIG. 2, the gesture may require that two hands are disposed within the field of view with the thumb and index finger of each hand in a pinching position for holding and manipulating a virtual catheter. One hand may remain stationary while the other hand may pivot about a point 126, such that the detection signal and the reference lookup table may be used to determine a desired articulation of the catheter toward a predetermined angle. Alternatively, in some embodiments which do not include a reference lookup table, an algorithm is used to process the detection signal to determine the desired articulation of the catheter or an elongate member toward a predetermined angle.

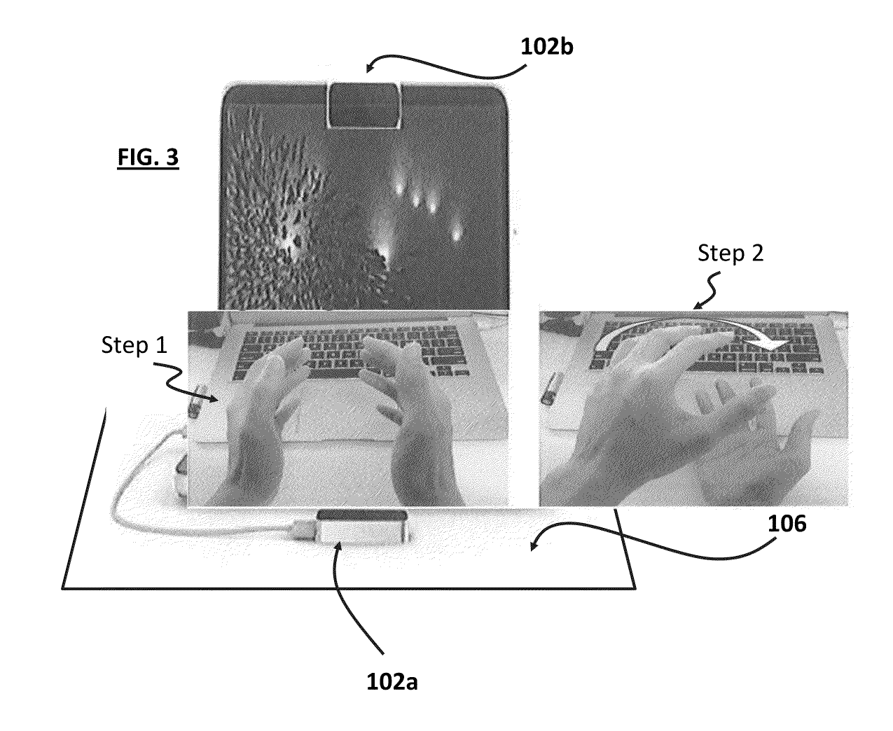

In some embodiments, each one of the interfaces 102a, 102b may be configured to permit movement of a 3D model on a display device 122. In such embodiments, the display device 122 is a fluoroscope configured to display a fluoroscopy view angle of a 3D model. The cameras 112 may be configured to generate a detection signal in response to detecting a gesture configured to move a virtual reference frame within the field of view 104. For example, as shown in FIG. 3, the cameras 112 may detect two hands holding and moving a virtual reference frame member within the field of view and generate a detection signal related to same. The controller 114 may then use the detection signal associated with the gesture to determine the reference detection data and corresponding reference command data. The controller may then generate the command signal based on reference command data, so as to change the fluoroscopy view angle of the 3D model on the display device 122 thus permitting control of the display device 122 by using the gesture.

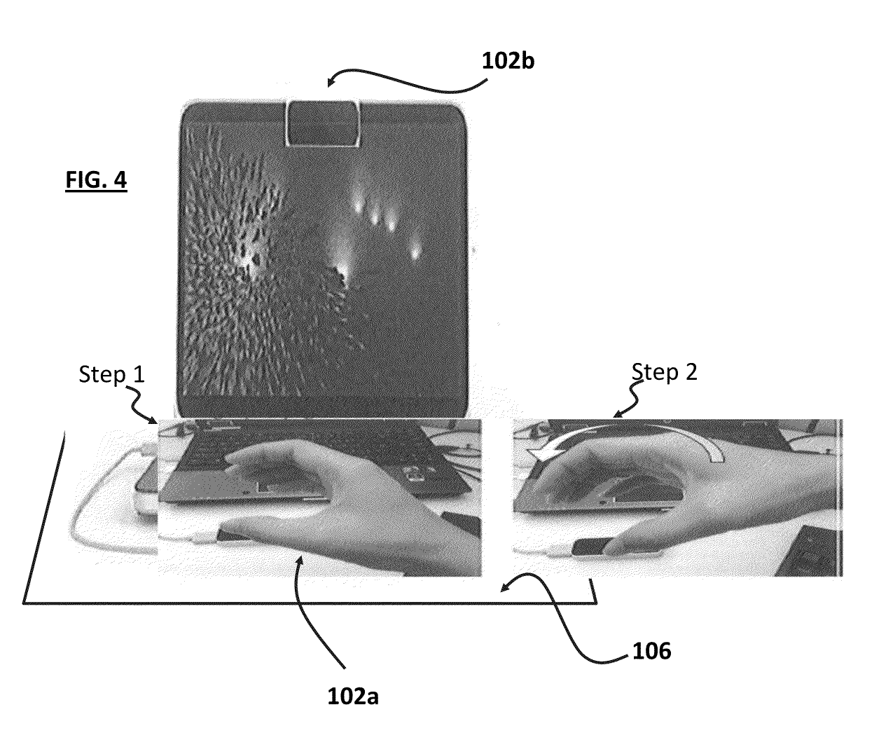

In some embodiments, the interfaces 102a, 102b are configured to permit control and operation of the C-arm 120 of the system 100. The C-arm 120 may be configured to carry an X-ray imaging device. For example, as shown in FIG. 4, the cameras 112 are configured to generate a detection signal in response to detecting a hand that is held in the shape of a C configuration. The controller 114 may use the detection signal associated with the gesture to determine the corresponding reference detection data and reference command data. The controller 114 may then generate the command signal based on the reference command data, such that the C-arm 120 may receive the command signal from the controller 114 and perform a function associated with the gesture.

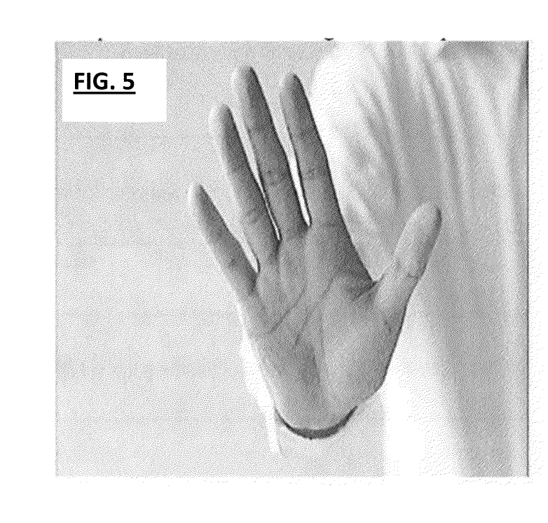

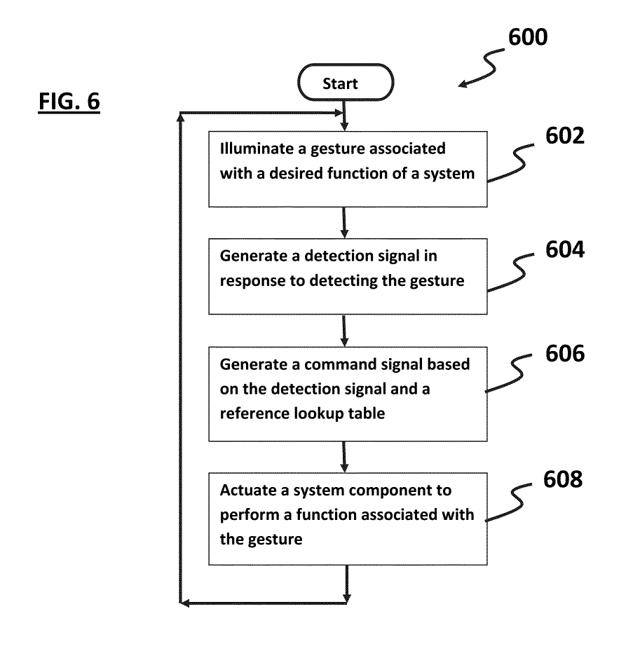

FIG. 6 illustrates a representative flow chart of a method 600 for operating the user interfaces 102a, 102b for the medical robotics system 100 of FIGS. 1A and 1B. At step 602, a gesture corresponding with a desired function of the system is illuminated within a field of view. For example, step 602 may be accomplished by one or more LEDs 110 illuminating a hand gesture or tool within the field of view 104. The hand gesture may be formed in a C-shape (e.g., FIG. 4) so as to control the C-arm 124. Furthermore, a hand gesture may be formed to include an index finger and a thumb disposed in a pinching position (e.g., FIG. 2) so as to manipulate a virtual catheter and thus operate the catheter 128 of the system 100. In some embodiments, a hand gesture may be formed to provide a pair of opposing cupped hands (e.g., FIG. 3) that hold and manipulate a virtual reference frame, so as to change a view angle shown on the display device 122. In some embodiments, a hand gesture includes a flat or open-faced palm (e.g., FIG. 5) to either disable or lock the user interface 102a, 102b and any other corresponding components of the system 100.

At step 604, one or more sensors can generate a detection signal in response to detecting the gesture within the field of view. For example, one or more infrared cameras 112 generate one or more detection signals in response to detecting the gesture within the field of view, and thus identify a static hand gesture, a dynamic hand movement, a static tool configuration, a dynamic tool movement or any combination thereof, which are associated with a desired function of the system.

At step 606, the controller 114 may generate the command signal based on the detection signal. In some embodiments, the controller 114 may access the reference lookup table stored in the medium 118 and determine reference command data and reference detection data corresponding with the detection signal. In such embodiments, the controller 114 may generate the command signal by matching the detection signal with corresponding reference detection data and the related reference command data. Further, in some embodiments, the controller may generate the command signal by using an algorithm to process the detection data, without using a reference lookup table.

At step 608, the instrument driver 120, the display device 122, the C-arm 124, other suitable components of the system or any combination thereof may be actuated to perform a function mapped to the gesture in response to the detection signal. For example, the C-arm 124 may be actuated to rotate toward various positions in response to the command signal. In some embodiments, the display device 122 can rotate, pan, enlarge, shrink or otherwise adjust a view in response to the command signal. Further, the catheter 128 may be actuated to articulate, roll, insert, or retract, in response to the command signal. The user interface may be used to operate any suitable portion of a medical device system, based on various gestures corresponding with the desired function to be performed by the system.

The exemplary systems and components described herein, including the various exemplary user interface devices, may include a computer or a computer readable storage medium implementing the operation of drive and implementing the various methods and processes described herein. In general, computing systems and/or devices, such as the processor and the user input device, may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., and the Android operating system developed by the Open Handset Alliance.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain examples, and should in no way be construed so as to limit the claims.

Accordingly, it is to be understood that the above description is intended to be illustrative and not restrictive. Many examples and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future examples. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A user interface for a medical robotics system, the user interface comprising:
multiple light sources configured to illuminate a gesture within a field of view;
multiple cameras having the field of view and being configured to generate a detection signal in response to detecting the gesture within the field of view; and
a controller configured to generate a command signal based on the detection signal, wherein the command signal is configured to actuate at least one of an instrument driver, a display device, or a C-arm configured to perform a function mapped to the gesture.

2. The user interface of claim 1, wherein the multiple cameras are configured to generate the detection signal in response to detecting the gesture provided by a hand or a tool.

3. The user interface of claim 1, further comprising a non-transitory computer readable medium storing a reference lookup table that includes multiple reference command data mapped to multiple reference detection data, such that the controller generates the command signal based on reference command data corresponding with the detection signal.

4. The user interface of claim 3, wherein the multiple cameras are configured to generate the detection signal in response to detecting the gesture that is configured to move a virtual elongate member within the field of view in at least one of a rolling motion, an articulation motion, an insertion motion, or a retraction motion.

5. The user interface of claim 4, wherein the multiple reference detection data correspond with the gesture moving the virtual elongate member in at least one of the rolling motion, the articulation motion, the insertion motion, or the retraction motion.

6. The user interface of claim 5, wherein the multiple reference command data are configured to actuate the instrument driver to move an elongate member in at least one of the rolling motion, the articulation motion, the insertion motion, or the refraction motion.

7. The user interface of claim 3, wherein the multiple cameras are configured to generate the detection signal in response to detecting the gesture that is configured to move a virtual reference frame within the field of view to change a fluoroscopy view angle.

8. The user interface of claim 7, wherein the multiple reference detection data correspond with the gesture that is configured to move the virtual reference frame to change the fluoroscopy view angle.

9. The user interface of claim 8, wherein the multiple reference command data are configured to actuate the display device to change the fluoroscopy view angle.

10. The user interface of claim 3, wherein the multiple cameras are configured to generate the detection signal in response to detecting the gesture that is configured to move a virtual C-arm within the field of view.

11. The user interface of claim 10, wherein the multiple reference detection data correspond with the gesture that is configured to move the virtual C-arm.

12. The user interface of claim 11, wherein the multiple reference command data are configured to actuate the C-arm to move an imaging device carried by the C-arm.

13. The user interface of claim 1, wherein the multiple light sources comprise infrared LEDs, and wherein the multiple cameras comprise infrared cameras.

14. A medical robotics system, comprising:
a user interface, comprising:
multiple light sources;
multiple cameras;
a controller; and
a non-transitory computer readable medium; and
at least one of an instrument driver, a display device, or a C-arm configured to perform a function mapped to a command signal in response to receiving a command signal from the controller,
wherein the multiple light sources are configured to illuminate a gesture within a field of view;
wherein the multiple cameras are configured to generate a detection signal in response to detecting the gesture;
wherein the controller is configured to generate the command signal in response to receiving the detection signal from the multiple cameras; and
wherein the non-transitory computer readable medium stores a reference lookup table that includes multiple reference command data mapped to multiple reference detection data, such that the controller generates the command signal based on the multiple reference command data corresponding with the detection signal.

15. The system of claim 14, wherein the display device is a fluoroscope configured to display a fluoroscopy view angle in response to the command signal.

16. The system of claim 14, wherein the C-arm is configured to move an X-ray imaging device in response to the command signal.

17. The system of claim 14, wherein the controller is configured to generate the command signal to lock at least one of an instrument driver, a display device or a C-arm in a current position.

18. A method for operating a user interface for a medical robotics system, the method comprising:
illuminating a gesture within a field of view;
generating a detection signal in response to detecting the gesture within the field of view;
generating a command signal in response to receiving the detection signal; and
actuating at least one of an instrument driver, a display device, or a C-arm configured to perform a function mapped to the gesture in response to the detection signal.

19. The method of claim 18, further comprising determining the command signal based on matching the detection signal with a corresponding reference detection data and reference command data in a reference lookup table stored within a non-transitory computer readable medium.

20. The method of claim 18, further comprising one or more of:
forming a hand gesture configured in a C-shape to control a C-arm;
forming a hand gesture having a pair of pinching fingers to manipulate a virtual catheter;
forming a hand gesture having a pair of opposing cupped hands to change a view angle on the display device; and
forming a hand gesture having a flat open palm to disable or lock the user interface.
